(19) United States
(12) Patent Application Publication
(10) Pub. No.: US 2026/0024910 A1
(43) Pub. Date: Jan. 22, 2026

(54) ANTENNA ASSEMBLY AND VEHICLE

(71) Applicant: HON HAI PRECISION INDUSTRY CO., LTD., New Taipei (TW)

(72) Inventors: KUO-HSI WU, New Taipei (TW); Ping-Hsung Ho, New Taipei (TW); Hsiang-Neng Wen, New Taipei (TW)

(21) Appl. No.: 18/952,976

(22) Filed: Nov. 19, 2024

(30) Foreign Application Priority Data
Jul. 18, 2024 (JP) 202410968393.9

(51) Int. Cl. H01Q 1/32; H01Q 1/48; H01Q 5/307; H01Q 9/04; H01Q 21/28

(52) U.S. Cl. CPC H01Q 1/32; H01Q 1/48; H01Q 5/307; H01Q 9/0414; H01Q 21/28

(57) ABSTRACT

An antenna assembly includes one or more antenna modules, each more antenna module include a substrate, a first antenna, a second antenna, a third antenna, and a fourth antenna, the substrate provides a first surface, the first surface provides a first clearance zone, a second clearance zone, a third clearance zone, and a ground zone; the first antenna, the second antenna, the third antenna, and the fourth antenna are arranged on the first surface and are electrically connected to the ground zone; an operating frequency band of the first antenna is in a first frequency band; an operating frequency band of the second antenna is in a second frequency band; an operating frequency band of the third antenna is in a third frequency band; an operating frequency band of the fourth antenna is in a fourth frequency band. A vehicle is also provided.

### FIELD

The present disclosure relates to field of antenna technology, particularly to an antenna assembly and a vehicle.

### BACKGROUND

Application of 5G communication technology and WIFI 6E can improve communication performance of vehicle network. Design of vehicle antennas needs to integrate operation bands of LTE, 5G-NR, and GNSS to meet the needs of vehicle communications, which may make miniaturization of antenna components difficult. Antenna components usually are installed outside the vehicle for improved communication performance of the antenna components. However, the antenna, such as a crocodile fin antenna assembly or a whip antenna assembly may be easily damages and the overall esthetic beauty of the vehicle may also be affected.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a schematic view of an antenna module in an embodiment of the present disclosure.

FIG. 2 illustrates a schematic view of an antenna assembly in another embodiment of the present disclosure.

FIG. 3 illustrates a schematic view of a first antenna in an embodiment of the present disclosure.

FIG. 4 illustrates a schematic view of a second antenna in an embodiment of the present disclosure.

FIG. 5 illustrates a schematic view of a third antenna in an embodiment of the present disclosure.

FIG. 6 illustrates a schematic view of a vehicle in an embodiment of the present disclosure.

### DETAILED DESCRIPTION

In order to make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it specifically indicates open-ended inclusion or membership in the so-described combination, group, series, and the like.

Unless otherwise defined, all technical and scientific terms used herein have the same meaning as commonly understood by one skilled in the art. The terms used in a specification of the present application herein are only for describing specific embodiments and are not intended to limit the present application. The terms “and/or” used herein comprises any and all combinations of one or more of associated listed items.

Some embodiments of the present application are described in detail. In the case of no conflict, the following embodiments and the features in the embodiments can be combined with each other.

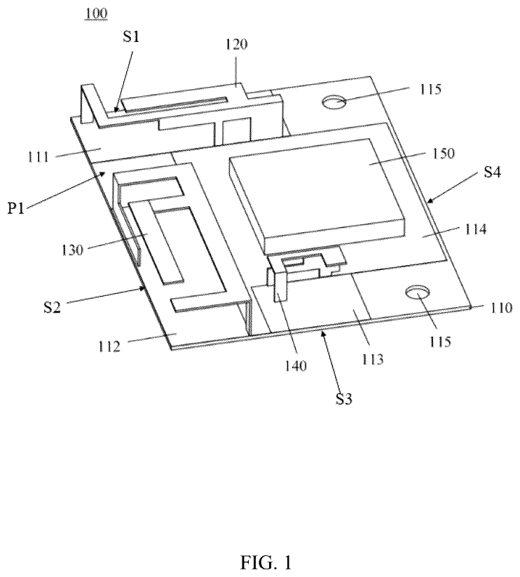

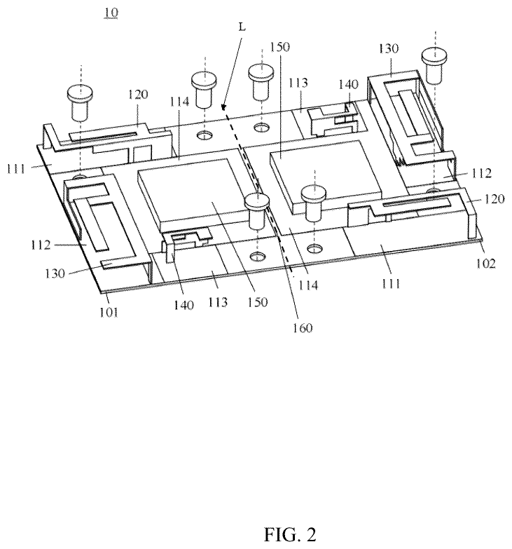

Referring to FIG. 1 and FIG. 2, illustrate an antenna assembly 10 according to an embodiment of the present application. The antenna assembly 10 includes one or more antenna modules 100, each antenna module 100 may include a substrate 110, a first antenna 120, a second antenna 130, a third antenna 140, and a fourth antenna 150, the substrate 110 provides a first surface P1, the first surface P1 provides a first clearance zone 111, a second clearance zone 112, a third clearance zone 113, and a ground zone 114. The first antenna 120, the second antenna 130, the third antenna 140, and the fourth antenna 150 are arranged on the first surface P1. The first antenna 120, the second antenna 130, the third antenna 140, and the fourth antenna 150 are electrically connected to the ground zone 114. A projection of the first antenna 120 on the first surface P1 falls into the first clearance zone 111, an operating frequency band of the first antenna 120 is in a first frequency band. A projection of the second antenna 130 on the first surface P1 falls into the second clearance zone 112, an operating frequency band of the second antenna 130 is in a second frequency band. A projection of the third antenna 140 on the first surface P1 falls into the third clearance zone 113, an operating frequency band of the third antenna 140 is in a third frequency band. A projection of the fourth antenna 150 on the first surface P1 falls into the ground zone 114, an operating frequency band of the fourth antenna 150 is in a fourth frequency band.

In the embodiment, the number of the antenna modules 100 can be set according to actual communication requirements. For example, when demand for automotive wireless communication increases, the number of the antenna modules 100 can be increased accordingly. A plurality of the antenna modules 100 has the same structure, which can achieve modularity and expansibility, and be convenient for layout when the number of the antenna modules 100 is increased or reduced. Modular antenna design is beneficial to save antenna material cost and shorten development cycle.

In one embodiment, the first surface P1 is a rectangular shaped, the first clearance zone 111 is arranged in a first side zone S1 of the first surface P1, the second clearance zone 112 is arranged in a second side zone S2 of the first surface P1, the third clearance zone 113 is arranged in a third side zone of S3 the first surface P1, the ground zone 114 is arranged in a fourth side zone S4 of the first surface P1, the first side zone S1 and the third side zone S3 are on opposite sides of a rectangle defined by the first surface P1, the second side zone S2 and the fourth side zone S4 are on opposite sides of the rectangle defined by the first surface P1.

The first clearance zone 111, the second clearance zone 112 and the third clearance zone 113 are arranged around the ground zone 114, so that the first antenna 120, the second antenna 130 and the third antenna 140 can be distributed on a side of the ground zone 114, and the fourth antenna 150 can be arranged above the ground area 114. A certain distance can be maintained between the four antennas to improve isolation, and a space on a surface of the substrate 110 can also be rationally utilized to achieve the miniaturization of the antenna assembly 10. The ground zone 114 can be a metal layer, such as copper foil, the ground zone 114 is laid on the surface of substrate 110 or on an inner layer of substrate 110. The first clearance zone 111, the second clearance zone 112, and the third clearance zone 113 is an area where copper foil is removed from the surface of the substrate 110. A shape of the substrate 110 can be set according to the actual application, for example, set to square, polygon, circle, oval, and so on.

In other embodiments, the substrate 110 can be a square shaped, and the ground zone 114 can also be a square shaped. One side of the ground zone 114 can coincide with one side of the substrate 110, and some intervals are between the other three sides of the ground zone 114 and the other three sides of the substrate 110, the intervals provide the first clearance zone 111, the second clearance zone 112 and the third clearance zone 113. Such a small, flat design can effectively reduce the size of the antenna to make installation position of the antenna assembly 10 more flexible. The positions of the first clearance zone 111, the second clearance zone 112 and the third clearance zone 113 can be set according to the actual application. For example, referring to FIG. 1, the first clearance zone 111 and the second clearance zone 112 can be arranged at two corners of the substrate 110 respectively, and the third clearance zone 113 can be arranged in a middle of a side of the substrate 110, and empty space zone in the substrate 110 can be used for mounting holes 115 for fixed installation of the antenna assembly 10.

In one embodiment, the first antenna 120 is a multiple-in multiple-out antenna, the first frequency band includes 1710 Mhz to 2700 Mhz and 3300 Mhz to 3800 Mhz. The second antenna 130 is a 5G antenna, the second frequency band includes 698 Mhz to 960 Mhz, 1710 Mhz to 2700 Mhz, and 3300 Mhz to 3800 Mhz. The third antenna 140 is a WIFI antenna, the third frequency band includes 2400 Mhz to 2500 Mhz and 5150 to 7125 Mhz. The fourth antenna is a Global Navigation Satellite System (GNSS) antenna, a center frequency point of the fourth frequency band includes 1176.45 Mhz and 1575.42 Mhz.

In one embodiment, the four antennas can meet the needs of multiple frequency bands, and the working frequency overlap between the four antennas is less, which can reduce the interference between the antennas.

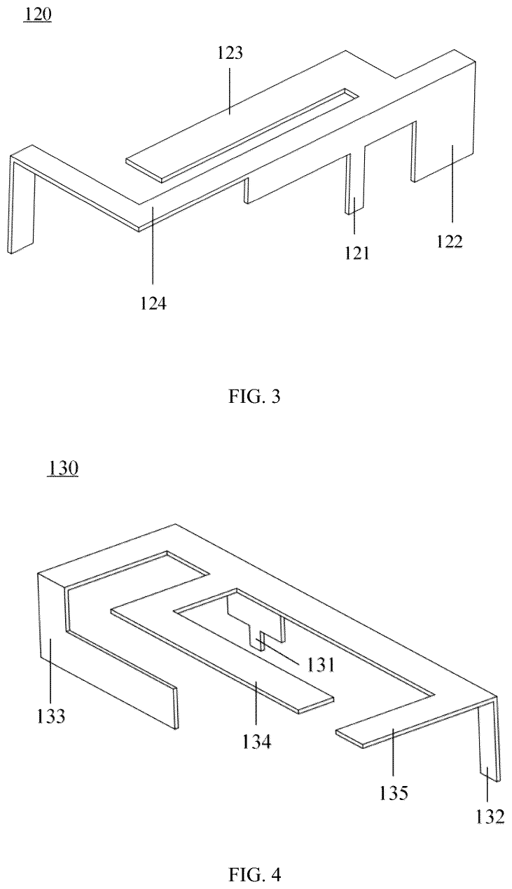

Referring to FIG. 3, the first antenna 120 includes a first feeding portion 121, a first ground portion 122, a first radiating portion 123, and a second radiating portion 124. The first feeding portion 121 and the first ground portion 122 are electrically connected to the ground zone 114, a first end of the first radiating portion 123 is electrically connected to the first feeding portion 121 and the first ground portion 122, the second radiating portion 124 is electrically connected to the first end of the first radiating portion 123, each of the first radiating portion 123 and the second radiating portion 124 is L-shaped.

In one embodiment, the first antenna 120 can be made of metal materials. For example, the first antenna 120 can be made of steel sheet molding. The first radiating portion 123 is high-frequency band branch knot, the second radiating portion 124 is low-frequency band branch knot. A first feed signal is input through the first feeding portion 121 and transmitted to the first radiation portion 123 and the second radiating portion 124 to generate radiation in the corresponding frequency band to achieve signal transmission. The first radiation portion 123 and the second radiating portion 124 are L-shape, a current path can be adjusted, and then radiation magnetic field can be adjusted to realize the radiation of the corresponding frequency band.

In one embodiment, the first antenna 120 also includes a first fixed portion. The first fixed portion is extended from the first radiation portion 123 in a direction parallel to the first feeding portion 121, the first fixed portion is fixed in the first clearance zone 111. Three support points of the first antenna 120 can improve the stability of the first antenna 120 and avoid collision and shaking during assembly, transportation and use.

Referring to FIG. 4, the second antenna 130 includes a second feeding portion 131, a second ground portion 132, a third radiating portion 133, a fourth radiating portion 134, and a fifth radiating portion 135. The second feeding portion 131 and the second ground portion 132 are electrically connected to the ground zone 114, a first end of the third radiating portion 133 is electrically connected to the second feeding portion 132, a first end of the fourth radiating portion 134 is electrically connected to the second feeding portion 131, a first end of the fifth radiating portion 135 is electrically connected to the second feeding portion 131, each of the third radiating portion 133, the fourth radiating portion 134, and the fifth radiating portion 135 is L-shaped.

In one embodiment, the second antenna 130 can be made of the metal materials. For example, the second antenna 130 can be made of the steel sheet molding. The third radiating portion 133 is the high-frequency band branch knot, the fourth radiating portion 134 is middle-frequency band branch knot, the fifth radiating portion 135 is the low-frequency band branch knot. A second feed signal is input through the second feeding portion 131 and transmitted to the third radiation portion 133, the fourth radiating portion 134, and the fifth radiating portion 135 to generate radiation in the corresponding frequency band to achieve signal transmission. The third radiation portion 133, the fourth radiating portion 134, and the fifth radiating portion 135 are L-shape, the current path can be adjusted, and then the radiation magnetic field can be adjusted to realize the radiation of the corresponding frequency band.

In one embodiment, a second end of the third radiating portion 133 can be bent in a direction away from the fourth radiating portion 134, a first L-shaped branch knot is formed between a plane perpendicular to a plane on which the fourth radiating portion 134 and the fifth radiating portion 135 are located and the second end of the third radiating portion 133. A side of the first L-shaped branch knot is fixed to the second clearance zone 112. Length of the third radiating portion 133 can be adjusted to realize adjustment of the radiation performance of the third radiating portion 133 in the high frequency band. Three support points of the second antenna 130 can improve the stability of the second antenna 130 and avoid the collision and shaking during assembly, transportation and use.

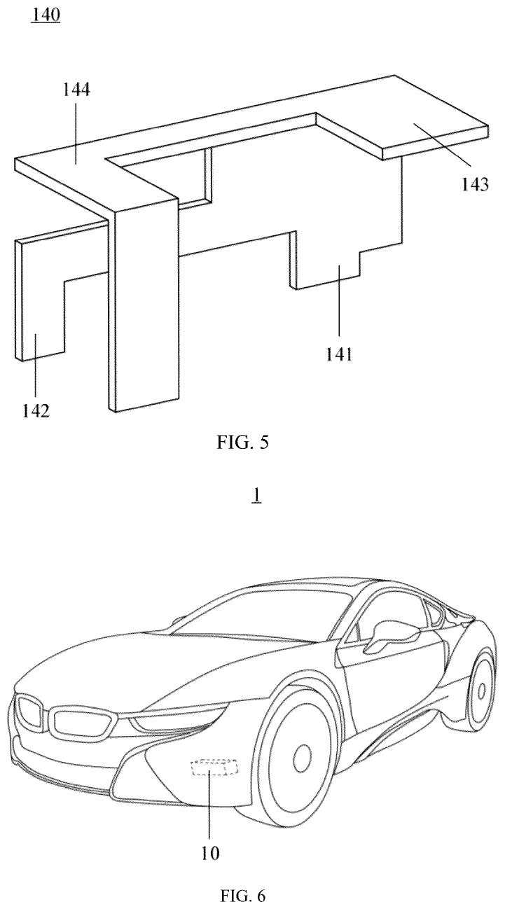

Referring to FIG. 5, the third antenna 140 includes a third feeding portion 141, a third ground portion 142, a sixth radiating portion 143, and a seventh radiating portion 144. The third feeding portion 141 is electrically connected to the ground zone 114, a first end of the third ground portion 142 is electrically connected to the third feeding portion 141, a second end of the third ground portion 142 is electrically connected to the ground zone 114. The third ground portion 142 is L-shaped. A first end of the sixth feeding portion 143 is electrically connected to the third feeding portion 141, a first end of the seventh feeding portion 144 is electrically connected to the third feeding portion 141.

In another embodiment, the third antenna 140 can be made of the metal materials. For example, the third antenna 140 can be made of the steel sheet molding. The sixth radiating portion 143 is the high-frequency band branch knot, the seventh radiating portion 124 is the low-frequency band branch knot. A third feed signal is input through the third feeding portion 141 and transmitted to the sixth radiation portion 143 and the seventh radiating portion 144 to generate the radiation in the corresponding frequency band to achieve the signal transmission. The sixth radiation portion 143 is strip shape or L-shape, the seventh radiating portion 144 is L-shape, the current path can be adjusted, and then the radiation magnetic field can be adjusted to realize the radiation of the corresponding frequency band.

In one embodiment, the seventh radiating portion 144 can be bent in a direction away from the sixth radiation portion 143, a second L-shaped branch knot is formed between a plane perpendicular to a plane on which the sixth radiation portion 143 is located and the seventh radiating portion 144. A side of the second L-shaped branch knot is fixed to the third clearance zone 113. Length of the seventh radiating portion 144 can be adjusted to realize the adjustment of the radiation performance of the seventh radiating portion 144 in the high frequency band. Three support points of the third antenna 140 can improve the stability of the third antenna 140 and avoid the collision and shaking during assembly, transportation and use.

In one embodiment, the fourth antenna 150 is a ceramic antenna, the fourth antenna 150 is fixed in the ground zone 114. The fourth antenna 150 includes a fourth feeding portion and a fourth ground portion. a fourth feed signal is input through the fourth feeding portion to stimulate the ceramic antenna to produce radiation in the corresponding frequency band to realize the signal transmission.

In one embodiment, the substrates 110 of the plurality of the antenna modules 100 are connected in one piece. In other embodiments, the plurality of the antenna modules 100 can use the one substrate 110 to save material.

In one embodiment, the antenna assembly 10 includes a first antenna module 101 and a second antenna module 102. The substrate 110 of the first antenna module 101 and the substrate 110 of the second antenna module 102 are integrally formed, a first interval 160 is formed between the ground zone 114 on the substrate 110 of the first antenna module 101 and the ground zone 114 on the substrate 110 of the second antenna module 102. A zone in the first interval 160 is a clearance zone, the clearance zone is one or more of the first clearance zone 111, the second clearance zone 112, and the third clearance zone 113.

In one embodiment, the first antenna module 101 and the second antenna module 102 are not in common ground by setting the first interval 160, the isolation of the first antenna module 101 and the second antenna module 102 is improved.

In one embodiment, the first antenna module 101 and the second antenna module 102 are distributed in a central symmetry mode. One side of the first antenna module 101 and one side of the second antenna module 102 are located in a first line L, and the first antenna module 101 and the second antenna module 102 are symmetrically arranged with the first line L as an axis.

In one embodiment, a side of the ground zone 114 on the substrate 110 of the first antenna module 101 is adjacent to a side of the ground zone 114 on the substrate 110 of the second antenna module 102, the first antenna module 101 and the second antenna module 102 are same structure, and the first antenna module 101 and the second antenna module 102 are distributed in the central symmetry mode. A certain distance can be maintained between the first antenna 120 of the first antenna module 101 and the first antenna 120 of the second antenna module 102 to reduce interference between the antennas in the same frequency band. A certain distance can be maintained between the second antenna 130 of the first antenna module 101 and the second antenna 130 of the second antenna module 102 to reduce interference between the antennas in the same frequency band. A certain distance can be maintained between the third antenna 140 of the first antenna module 101 and the third antenna 140 of the second antenna module 102 to reduce interference between the antennas in the same frequency band. The first interval 160 between the ground zone 114 of the first antenna module 101 and the ground zone 114 of the second antenna module 102 to improve the isolation of the first antenna module 101 and the second antenna module 102.

In one embodiment, the substrate 110 defines one or more mounting holes 115. The one or more mounting holes 115 can be arranged in a corner zone or a side zone of the substrate 110 avoiding some clearance zones and the ground zone 114, which reduces the interference to the antenna and improve the stability of the antenna assembly 10.

For example, the substrate 110 defines three mounting holes 115. The first mounting hole 115 is arranged in a corner closer to the first antenna 120, the second mounting hole 115 is arranged in a corner closer to the third antenna 140, the third mounting hole 115 is arranged in a rewinding interval zone between the first antenna 120 and the second antenna 130.

In one embodiment, the one or more mounting holes 115 can be used with mounting pieces to secure the antenna assembly 10, for example, screws. Thus, the reliability of the antenna assembly 10 can be increased by designing the one or more mounting holes 115 at key locations, the impact of vibration on the antenna can be reduced, and the communication quality of the antenna assembly 10 can be ensured.

In one embodiment, the antenna assembly 10 also includes one or more shells, an accommodating cavity is formed between the one or more shells and the substrate 110, the first surface P1 of the substrate 110 is facing the accommodating cavity.

In one embodiment, the one or more shells can protect the antennas in the accommodating cavity. Shapes of the one or more shells can be designed according to the shape of the substrate 110. For example, when the substrate 110 is square, the one or more shells can be set to a square. The antenna assembly 10 can be installed in different positions to improve the flexibility of the antenna assembly 10.

In one embodiment, when the multiple antenna modules 100 use the same substrate 110, the number of shells can be one. When the multiple antenna modules 100 have the multiple substrates 110, the number of shells can be multiple, so that the multiple antenna modules 100 can be installed in different positions.

In one embodiment, the one or more antenna modules 100 can have same structure, the number of the antenna modules 100 and the installation positions of the one or more antenna modules 100 can be adjusted according to the actual demand. The antenna assembly 10 can be easily expanded and adjusted to convenient for rapid optimization and improve design efficiency and flexibility.

Refer to FIG. 6, illustrates a vehicle 1 according to an embodiment of the present application, the vehicle 1 includes the antenna assembly 10.

In one embodiment, the vehicle 1 includes a front post, a rear post, a bumper, a fender, and a spoiler. The antenna assembly 10 includes the one or more antenna modules 100 mounted on any of the front post, the rear post, the bumper, the fender, and the spoiler.

In one embodiment, the one or more antenna modules 100 can have same structure, the number of the antenna modules 100 and the installation positions of the one or more antenna modules 100 can be adjusted according to the actual demand. For example, the one or more antenna modules 100 can be arranged on the roof of the vehicle 1 for taking into account the quality of signal reception. A flat quadrangle is formed between the one or more antenna modules 100 with the shell, and the one or more antenna modules 100 can also be installed in the roof of the vehicle 1. The one or more antenna modules 100 can be hidden in the vehicle 1, which has no impact on the shape of vehicle 1, keeps the body line smooth, and improves the beauty of vehicle 1.

In other embodiments, in the vehicle 1 with a panoramic glass sunroof, the one or more antenna modules 100 can also be installed anywhere in the front post, the rear post, the bumper, the fender, and the spoiler. Communication quality is guaranteed while invisibility of the one or more antenna modules 100 is achieved.

When communication demand of the vehicle 1 increases, the number of the one or more antenna modules 100 can be increased accordingly. For example, the number of the one or more antenna modules 100 is two. The two antenna modules 100 can be installed in one position, or the two antenna modules 100 can be installed separately in different positions of the vehicle 1. Modular antenna design makes the antenna assembly 10 easy to expand and adjust, the design efficiency and flexibility is improved.

It is to be understood, even though information and advantages of the present embodiments have been set forth in the foregoing description, together with details of the structures and functions of the present embodiments, the disclosure is illustrative only, changes may be made in detail, especially in matters of shape, size, and arrangement of parts within the principles of the present embodiments to the full extent indicated by the plain meaning of the terms in which the appended claims are expressed.

What is claimed is:

1. An antenna assembly comprising:
one or more antenna modules each comprising a substrate; a first antenna; a second antenna; a third antenna; and a fourth antenna, wherein:
the substrate provides a first surface providing a first clearance zone, a second clearance zone, a third clearance zone, and a ground zone;
the first antenna, the second antenna, the third antenna, and the fourth antenna are arranged on the first surface;
the first antenna, the second antenna, the third antenna, and the fourth antenna are electrically connected to the ground zone;
a projection of the first antenna on the first surface falls into the first clearance zone, an operating frequency band of the first antenna is in a first frequency band;
a projection of the second antenna on the first surface falls into the second clearance zone, an operating frequency band of the second antenna is in a second frequency band;
a projection of the third antenna on the first surface falls into the third clearance zone, an operating frequency band of the third antenna is in a third frequency band; and
a projection of the fourth antenna on the first surface falls into the ground zone, an operating frequency band of the fourth antenna is in a fourth frequency band.

2. The antenna assembly as claimed in claim 1, wherein the first frequency band comprises 1710 Mhz to 2700 Mhz and 3300 Mhz to 3800 Mhz, the second frequency band comprises 698 Mhz to 960 Mhz, 1710 Mhz to 2700 Mhz, and 3300 Mhz to 3800 Mhz, the third frequency band comprises 2400 Mhz to 2500 Mhz and 5150 to 7125 Mhz, a center frequency point of the fourth frequency band comprises 1176.45 Mhz and 1575.42 Mhz.

3. The antenna assembly as claimed in claim 1, wherein the first antenna comprises a first feeding portion, a first ground portion, a first radiating portion, and a second radiating portion, the first feeding portion and the first ground portion are electrically connected to the ground zone, a first end of the first radiating portion is electrically connected to the first feeding portion and the first ground portion, the second radiating portion is electrically connected to the first end of the first radiating portion, each of the first radiating portion and the second radiating portion is L-shaped.

4. The antenna assembly as claimed in claim 1, wherein the second antenna comprises a second feeding portion, a second ground portion, a third radiating portion, a fourth radiating portion, and a fifth radiating portion, the second feeding portion and the second ground portion are electrically connected to the ground zone, a first end of the third radiating portion is electrically connected to the second feeding portion, a first end of the fourth radiating portion is electrically connected to the second feeding portion, a first end of the fifth radiating portion is electrically connected to the second feeding portion, each of the third radiating portion, the fourth radiating portion, and the fifth radiating portion is L-shaped.

5. The antenna assembly as claimed in claim 1, wherein the third antenna comprises a third feeding portion, a third ground portion, a sixth radiating portion, and a seventh radiating portion, the third feeding portion is electrically connected to the ground zone, a first end of the third ground portion is electrically connected to the third feeding portion, a second end of the third ground portion is electrically connected to the ground zone, the third ground portion is L-shaped; a first end of the sixth feeding portion is electrically connected to the third feeding portion, a first end of the seventh feeding portion is electrically connected to the third feeding portion.

6. The antenna assembly as claimed in claim 1, wherein the fourth antenna is a ceramic antenna; the fourth antenna is fixed in the ground zone.

7. The antenna assembly as claimed in claim 1, wherein the first surface is rectangle shaped, the first clearance zone is arranged in a first side zone of the first surface, the second clearance zone is arranged in a second side zone of the first surface, the third clearance zone is arranged in a third side zone of the first surface, the ground zone is arranged in a fourth side zone of the first surface, the first side zone and the third side zone are on opposite sides of a rectangle defined by the first surface, the second side zone and the fourth side zone are on opposite sides of the rectangle defined by the first surface.

8. The antenna assembly as claimed in claim 1, wherein the one or more antenna modules comprises a first antenna module and a second antenna module, the substrate of the first antenna module and the substrate of the second antenna module are integrally formed, a first interval is formed between the ground zone on the substrate of the first antenna module and the ground zone on the substrate of the second antenna module.

9. The antenna assembly as claimed in claim 8, wherein the first antenna module and the second antenna module are distributed in a central symmetry mode, one side of the first antenna module and one side of the second antenna module are located in a first line, and the first antenna module and the second antenna module are symmetrically arranged with the first line as an axis, a zone within the first interval is a clearance zone, the clearance zone is one or more of the first clearance zone, the second clearance zone, and the third clearance zone.

10. A vehicle comprising:
an antenna assembly, wherein the antenna assembly comprises one or more antenna modules, each antenna module comprises a substrate, a first antenna, a second antenna, a third antenna, and a fourth antenna; the substrate provides a first surface, the first surface provides a first clearance zone, a second clearance zone, a third clearance zone, and a ground zone; the first antenna, the second antenna, the third antenna, and the fourth antenna are arranged on the first surface; the first antenna, the second antenna, the third antenna, and the fourth antenna are electrically connected to the ground zone; a projection of the first antenna on the first surface falls into the first clearance zone, an operating frequency band of the first antenna is in a first frequency band; a projection of the second antenna on the first surface falls into the second clearance zone, an operating frequency band of the second antenna is in a second frequency band; a projection of the third antenna on the first surface falls into the third clearance zone, an operating frequency band of the third antenna is in a third frequency band; and a projection of the fourth antenna on the first surface falls into the ground zone, an operating frequency band of the fourth antenna is in a fourth frequency band.

11. The vehicle as claimed in claim 10, wherein the first frequency band comprises 1710 Mhz to 2700 Mhz and 3300 Mhz to 3800 Mhz, the second frequency band comprises 698 Mhz to 960 Mhz, 1710 Mhz to 2700 Mhz, and 3300 Mhz to 3800 Mhz, the third frequency band comprises 2400 Mhz to 2500 Mhz and 5150 to 7125 Mhz, a center frequency point of the fourth frequency band comprises 1176.45 Mhz and 1575.42 Mhz.

12. The vehicle as claimed in claim 10, wherein the first antenna comprises a first feeding portion, a first ground portion, a first radiating portion, and a second radiating portion, the first feeding portion and the first ground portion are electrically connected to the ground zone, a first end of the first radiating portion is electrically connected to the first feeding portion and the first ground portion, the second radiating portion is electrically connected to the first end of the first radiating portion, each of the first radiating portion and the second radiating portion is L-shaped.

13. The vehicle as claimed in claim 10, wherein the second antenna comprises a second feeding portion, a second ground portion, a third radiating portion, a fourth radiating portion, and a fifth radiating portion, the second feeding portion and the second ground portion are electrically connected to the ground zone, a first end of the third radiating portion is electrically connected to the second feeding portion, a first end of the fourth radiating portion is electrically connected to the second feeding portion, a first end of the fifth radiating portion is electrically connected to the second feeding portion, each of the third radiating portion, the fourth radiating portion and the fifth radiating portion is L-shaped.

14. The vehicle as claimed in claim 10, wherein the third antenna comprises a third feeding portion, a third ground portion, a sixth radiating portion, and a seventh radiating portion, the third feeding portion is electrically connected to the ground zone, a first end of the third ground portion is electrically connected to the third feeding portion, a second end of the third ground portion is electrically connected to the ground zone, the third ground portion is L-shaped; a first end of the sixth feeding portion is electrically connected to the third feeding portion, a first end of the seventh feeding portion is electrically connected to the third feeding portion.

15. The vehicle as claimed in claim 10, wherein the fourth antenna is a ceramic antenna; the fourth antenna is fixed in the ground zone.

16. The vehicle as claimed in claim 10, wherein the first surface is a rectangle shaped, the first clearance zone is arranged in a first side zone of the first surface, the second clearance zone is arranged in a second side zone of the first surface, the third clearance zone is arranged in a third side zone of the first surface, the ground zone is arranged in a fourth side zone of the first surface, the first side zone and the third side zone are on opposite sides of a rectangle defined by the first surface, the second side zone and the fourth side zone are on opposite sides of the rectangle defined by the first surface.

17. The vehicle as claimed in claim 10, wherein the one or more antenna modules comprises a first antenna module and a second antenna module, the substrate of the first antenna module and the substrate of the second antenna module are integrally formed, a first interval is formed between the ground zone on the substrate of the first antenna module and the ground zone on the substrate of the second antenna module.

18. The vehicle as claimed in claim 17, wherein the first antenna module and the second antenna module are distributed in a central symmetry mode, one side of the first antenna module and one side of the second antenna module are located in a first line, and the first antenna module and the second antenna module are symmetrically arranged with the first line as an axis, a zone within the first interval is a clearance zone, the clearance zone is one or more of the first clearance zone, the second clearance zone, and the third clearance zone.
